(19) United States
(12) Patent Application Publication
(10) Pub. No.: US 2017/0155282 A1
(43) Pub. Date: Jun. 1, 2017

(54) ENHANCED COUPLING IN A WEARABLE RESONATOR

(71) Applicant: QUALCOMM Incorporated, San Diego, CA (US)

(72) Inventor: Seong Heon Jeong, San Diego, CA (US)

(21) Appl. No.: 15/191,329

(22) Filed: Jun. 23, 2016

Related U.S. Application Data
(60) Provisional application No. 62/261,173, filed on Nov. 30, 2015.

(51) Int. Cl. H02J 50/12; H02J 7/02

(52) U.S. Cl. CPC H02J 50/12; H02J 7/025

(57) ABSTRACT

Disclosed embodiments include magnetically coupling an externally generated magnetic field to a power receiving element arranged with a band that is configured to secure a wearable electronic device to a user. The power receiving element may extend a length of the band and traverse back and forth across a width of the band. Power induced in the power receiving element from the externally generated magnetic field may be generated to produce wirelessly received power for the wearable electronic device.

### CROSS REFERENCE TO RELATED APPLICATIONS

Pursuant to 35 U.S.C. §119(e), this application is entitled to and claims the benefit of the filing date of U.S. Provisional App. No. 62/261,173, filed Nov. 30, 2015, the content of which is incorporated herein by reference in its entirety for all purposes.

### TECHNICAL FIELD

The present disclosure relates generally to wireless power transfer systems. More particularly, the present disclosure relates to wearable electronic devices having resonators for wireless power transfer.

### BACKGROUND

Wireless power transfer is an increasingly popular capability in portable electronic devices, such as mobile phones, computer tablets, etc. because such devices typically require long battery life and low battery weight. The ability to power an electronic device without the use of wires provides a convenient solution for users of portable electronic devices. Wireless power charging systems, for example, may allow users to charge and/or power electronic devices without physical, electrical connections, thus reducing the number of components required for operation of the electronic devices and simplifying the use of the electronic device.

Wireless power transfer allows manufacturers to develop creative solutions to problems due to having limited power sources in consumer electronic devices. Wireless power transfer may reduce overall cost (for both the user and the manufacturer) because conventional charging hardware such as power adapters and charging chords can be eliminated. There is flexibility in having different sizes and shapes in the components (e.g., magnetic coil, charging plate, etc.) that make up a wireless power transmitter and/or a wireless power receiver in terms of industrial design and support for a wide range of devices, from mobile handheld devices to computer laptops.

Wearable electronic devices having wireless power transfer capability are becoming increasingly common. Providing suitable power receiving capacity in a wearable device is challenging because of the limited space that a wearable device provides.

### SUMMARY

In accordance with some embodiments, a method may include magnetically coupling to an externally generated magnetic field via a power receiving element. The power receiving element may be arranged with a band that is configured to secure a wearable electronic device to a user. The power receiving element may extend a length of the band and traverse back and forth across the width of the band. The method may include generating wirelessly received power for the wearable electronic device from power induced in the power receiving element from the externally generated magnetic field.

In some aspects, the method may further include intersecting first flux lines of the externally generated magnetic field at several locations on the power receiving element.

In some aspects, the method may include coupling the externally generated magnetic field to the power receiving element equally strongly irrespective of whether a first side of the band or a second side of the band is closer to a charging surface from which the externally generated magnetic field emanates.

In some aspects, the power receiving element may have a pattern that is symmetric about a longitudinal axis along the length of the band.

In some aspects, the power receiving element may traverse back and forth across the width of the band with a repeating pattern.

In some aspects, the power receiving element may extend around a circumference of the band one or more times.

In some aspects, the method may further include connecting together a first segment of the power receiving element and a second segment of the power receiving element. In some aspects, the method may further include configuring the band to a CLOSED position to connect together a first segment of the power receiving element and a second segment of the power receiving element.

In some aspects, the method may further include operating the power receiving element at a frequency substantially equal to a frequency of the externally generated magnetic field.

In some aspects, the method may further include setting a resonant frequency of the power receiving element substantially equal to a frequency of the externally generated magnetic field.

In some aspects, the method may further include rectifying the power induced in the power receiving element to produce the wirelessly received power.

In accordance with some embodiments, an electronic device may include a band configured to secure an electronic device to a user. A power receiving element may be arranged along a length of the band and shaped to form a pattern that spans a width of the band. The power receiving element may have an electrical connection to the electronic circuitry at the first location of the device body and at the second location of the device body. The power receiving element may be configured to couple to an externally generated magnetic field to wirelessly receive power from a source of the externally generated magnetic field.

In some aspects, first flux lines of the externally generated magnetic field may intersect the power receiving element at several locations on the power receiving element.

In some aspects, the pattern may be symmetric about a longitudinal axis of the band.

In some aspects, the power receiving element may couple equally in strength to the externally generated magnetic field when a first side of the electronic device lies on a charging device that produces the externally generated magnetic field as it does when the electronic device lies on the charging surface on a second side of the electronic device.

In some aspects, the pattern may be a repeating pattern.

In some aspects, the pattern may traverse back and forth across the width of the band.

In some aspects, the power receiving element may comprises a first segment and a second segment. The band may comprise a first band segment arranged with the first segment of the power receiving element and a second band segment arranged with the second segment of the power receiving element. An engagement mechanism may be configured to mechanically engage and disengage the first and second band segments.

In some aspects, the power receiving element may define a single turn around a circumference of the band when the band is in a CLOSED configuration.

In some aspects, the power receiving element may define at least two turns around a circumference of the band when the band is in a CLOSED configuration.

In accordance with some embodiments, an electronic device may include means for magnetically coupling to an externally generated magnetic field. The means for magnetically coupling may be arrange with a band that is configured to secure a wearable electronic device to a user. The means for magnetically coupling may extend a length of the band and traverse back and forth across a width of the band. The electronic device may further include means for generating wirelessly received power for the wearable electronic device from power induced in the means for magnetically coupling.

In some aspects, the means for magnetically coupling may couple equally strongly to the externally generated magnetic field irrespective of whether a first side of the band or a second side of the band is closer to a charging surface from which the externally generated magnetic field emanates.

In some aspects, the means for magnetically coupling may have a pattern that is symmetric about a longitudinal axis along the length of the band.

In some aspects, the means for magnetically coupling may traverse back and forth across the width of the band with a repeating pattern.

In some aspects, the means for magnetically coupling may extend around a circumference of the band one or more times.

In some aspects, the electronic device may include means for connecting together first and second segments that comprise the means for magnetically coupling.

In some aspects, the electronic device may include means for configuring the band to a CLOSED position to connect together first and second segments that comprise the means for magnetically coupling.

In some aspects, the electronic device may include means for setting a resonant frequency of the means for magnetically coupling substantially equal to a frequency of the externally generated magnetic field.

In some aspects, the electronic device may include means for rectifying the power induced in the means for magnetically coupling to generate the wirelessly received power.

In accordance with some embodiments, an apparatus for wireless power transfer may include a band configured to secure an electronic device to a user and a power receiving element comprising a winding of conductive material arranged to repeatedly cross a longitudinal axis running along a length of the band and that forms a pattern along a width of the band. The power receiving element may be configured to inductively couple to an externally generated magnetic field to wirelessly receive power from a source of the externally generated magnetic field.

In some aspects, a portion of a first segment of the pattern that runs along an upper portion of the band substantially parallel to the longitudinal axis may overlap a portion of a second segment of the pattern that runs along a lower portion of the band substantially parallel to the longitudinal axis.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 is a functional block diagram of a wireless power transfer system in accordance with an illustrative embodiment.

FIG. 2 is a functional block diagram of a wireless power transfer system in accordance with an illustrative embodiment.

FIG. 3 is a schematic diagram of a portion of transmit circuitry or receive circuitry of FIG. 2 including a power transmitting or receiving element in accordance with an illustrative embodiment.

FIG. 4 shows an illustrative embodiment of a wearable electronic device in accordance with the present disclosure.

FIGS. 4A and 4B illustrate respective OPEN and CLOSED positions of the wearable electronic device of FIG. 4.

FIG. 5 is a photo of a mockup of a power receiving element in accordance with the present disclosure.

FIG. 5A is schematic representation of the power receiving element of FIG. 5.

FIGS. 6A, 6B, 6C show illustrative examples of power receiving elements in accordance with the present disclosure.

FIG. 7 is a photo of a mockup of a power receiving element in accordance with the present disclosure.

FIGS. 7A and 7B show additional examples of power receiving elements in accordance with the present disclosure.

FIGS. 8, 9A, and 9B illustrate circuitry used with a power receiving element.

FIGS. 10 and 10A demonstrate an aspect of a power receiving element in accordance with the present disclosure.

FIGS. 11, 11A, 11B, and 11C illustrate aspects of a power receiving element in accordance with the present disclosure.

### DETAILED DESCRIPTION

Drawing elements that are common among the following figures may be identified using the same reference numerals.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

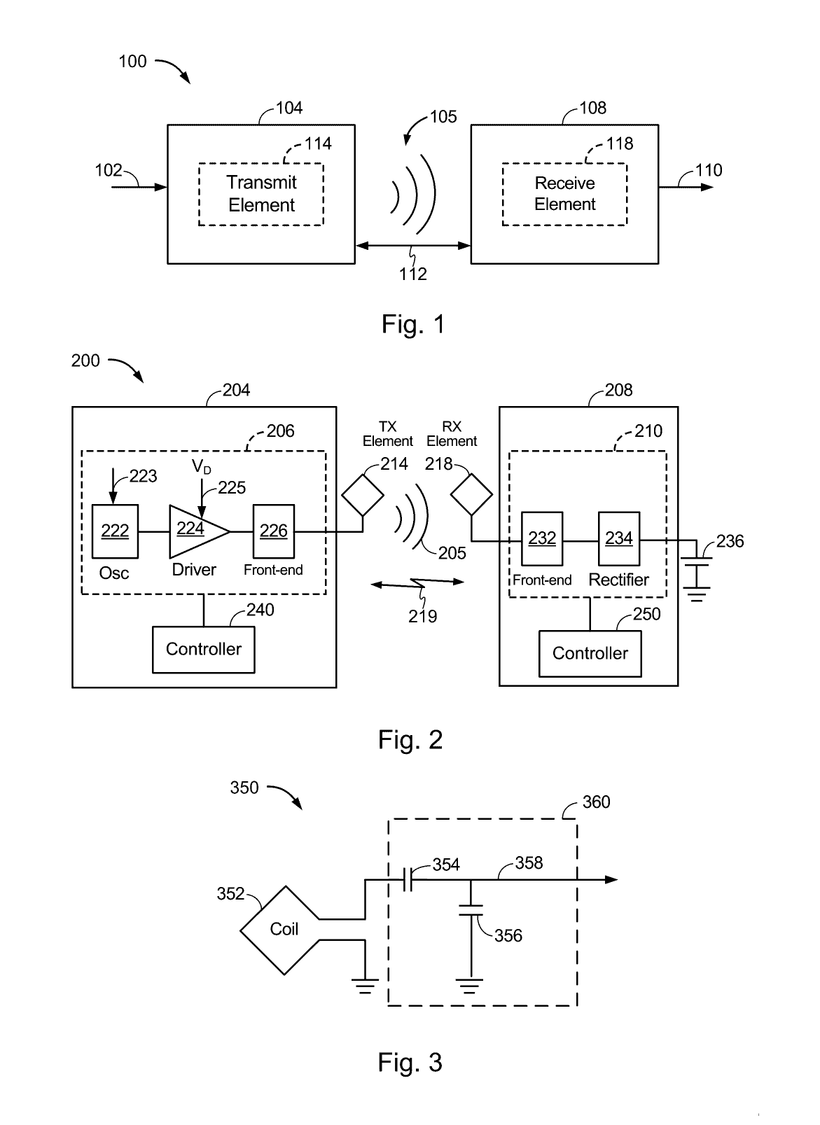

FIG. 1 is a functional block diagram of a wireless power transfer system 100, in accordance with an illustrative embodiment. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative embodiment, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain embodiments, the wireless field 105 may correspond to the “near field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114.

In certain embodiments, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

FIG. 2 is a functional block diagram of a wireless power transfer system 200, in accordance with another illustrative embodiment. The system 200 may include a transmitter 204 and a receiver 208. The transmitter 204 (also referred to herein as power transfer unit, PTU) may include transmit circuitry 206 that may include an oscillator 222, a driver circuit 224, and a front-end circuit 226. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load.

The transmitter 204 may further include a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. In certain embodiments, the transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller 250 configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter 204 and the receiver 208.

FIG. 3 is a schematic diagram of a portion of the transmit circuitry 206 or the receive circuitry 210 of FIG. 2, in accordance with illustrative embodiments. As illustrated in FIG. 3, transmit or receive circuitry 350 may include a power transmitting or receiving element 352 and a tuning circuit 360. The power transmitting or receiving element 352 may also be referred to or be configured as an antenna or a “loop” antenna. The term “antenna” generally refers to a component that may wirelessly output or receive energy for coupling to another antenna. The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non limiting example, the tuning circuit 360 may comprise a capacitor 354 and a capacitor 356, which may be added to the transmit and/or receive circuitry 350 to create a resonant circuit.

The tuning circuit 360 may include other components to form a resonant circuit with the power transmitting or receiving element 352. As another non limiting example, the tuning circuit 360 may include a capacitor (not shown) placed in parallel between the two terminals of the circuitry 350. Still other designs are possible. In some embodiments, the tuning circuit in the front-end circuit 226 may have the same design (e.g., 360) as the tuning circuit in front-end circuit 232. In other embodiments, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

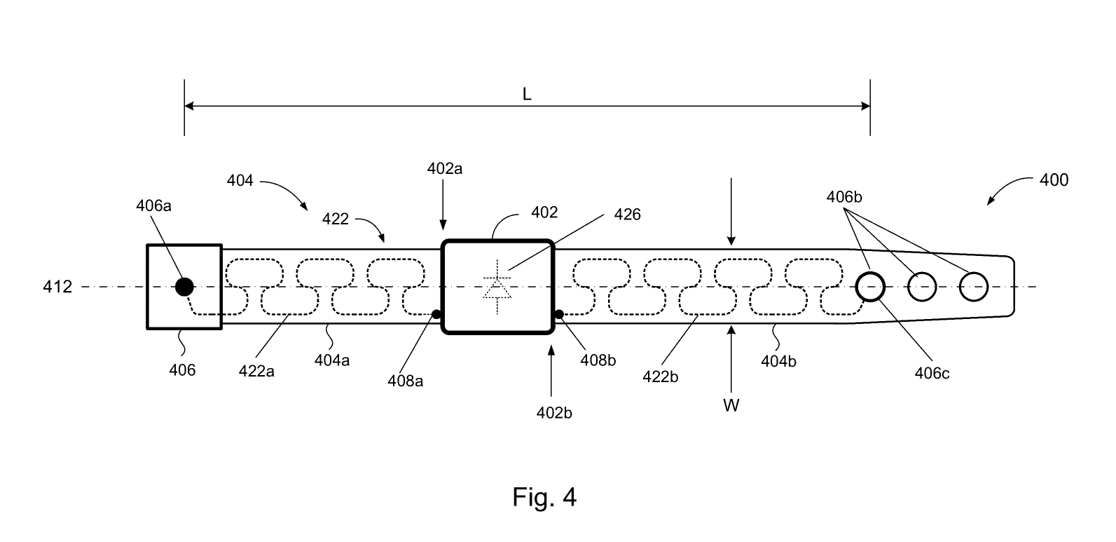

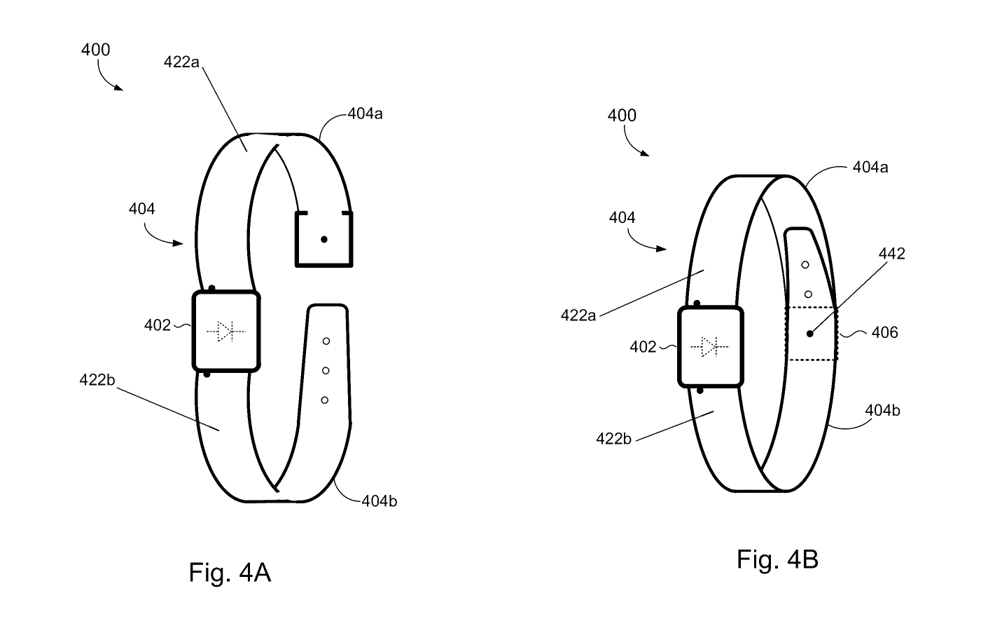

FIGS. 4, 4A, and 4B show aspects of a wearable electronic device 400 configured for wireless power transfer in accordance with the present disclosure. The electronic device 400 may be a digital watch, a wearable computer, a health monitor, or any other electronic equipment that can be worn by a user. The electronic device 400 may include a rechargeable power source (e.g., rechargeable battery, not shown) to provide power to electronic components (not shown) in the electronic device 400.

The electronic device 400 may include a device body 402. In some embodiments, the device body 402 may house various components (not shown) to display information (output) to a user and to receive information (input) from a user, and electronics (not shown) to support the various components. In accordance with the present disclosure, the device body 402 may include circuitry 426 configured to provide wirelessly received power to the various electronics and other electrical components in the device body 402.

The electronic device 400 may include a band 404; for example, a wristband. In some embodiments, the band 404 may include a first band segment 404a and a second band segment 404b. The band segment 404a may be attached to the device body 402 at location 402a of the device body 402. Similarly, the band segment 404b may be attached to the device body 402 at location 402b of the device body 402. Any suitable mechanical attachment may be used; for example, a rigid attachment, a hinged attachment, and so on.

The band 404 may include means for connecting together the band segments 404a, 404b, thus configuring the band 404 in a CLOSED position. For example, the band 404 may include an engagement mechanism 406. In some embodiments, the engagement mechanism 406 may include a post 406a arranged on one of the band segments 404a. The post 406a may engage with post openings 406b formed on the other of the band segments 404b. The engagement mechanism 406 can mechanically engage and disengage the first and second band segments 404a, 404b. FIG. 4A, for example, shows band 404 in an OPEN position (configuration), where the first and second band segments 404a, 404b are disengaged. FIG. 4B shows band 404 in a CLOSED position, where the first and second band segments 404a, 404b are engaged by the engagement mechanism 406.

The electronic device 400 may include means for magnetically coupling to an externally generated magnetic field (e.g., field 105, FIG. 1). In some embodiments, for example, the means for magnetically coupling to an externally generated magnetic field may be a power receiving element 422. In some embodiments, the power receiving element 422 may include a first segment 422a and a second segment 422b. In some embodiments, the segments 422a, 422b may be formed within the material (e.g., leather, flexible plastic, etc.) used for band 404. In other embodiments, the segments 422a, 422b may be arranged on or near the surface of the band 404. In other embodiments, the power receiving element 422 may comprise a single segment. For example, in some embodiments the electronic device 400 may be a bracelet or other similar wearable ornament that does not have an OPEN position as shown for example in FIG. 4A. The remaining disclosure will assume without loss of generality the embodiments shown in FIGS. 4,4A, and 4B.

The segments 422a, 422b of the power receiving element 422 may be connected to the circuitry 426 at the locations 402a, 402b of the device body 402. In some embodiments, for example, one end of the first segment 422a of power receiving element 422 may connect to circuitry 426 via a terminal 408a at the first location 402a of the device body 402. Likewise, one end of the second segment 422b of power receiving element 422 may connect to circuitry 426 via a terminal 408b at the second location 402b of the device body 402.

In some embodiments, another end of the first segment 422a may have a connection (node) at post 406a. The post 406a may have an outer coating of electrically conductive material, or may be made from an electrically conductive material. Similarly, another end of the second segment 422b may have a connection (node) at one of the post openings 406c. The post opening 406c may have an outer coating of electrically conductive material, or may be made from an electrically conductive material.

Referring to FIG. 4B, when the band 404 is in the particular CLOSED position shown, the post 406a is engaged with post opening 406c. In this particular CLOSED position, the first and second segments 422a, 422b of power receiving element 422 are connected together at node 442, which is spaced apart (separate) from the device body 402. As will be explained below, power receiving element 422 completes (defines) a circuit with circuitry 426 when the band 404 is in the particular CLOSED position shown in FIG. 4B.

In accordance with the present disclosure, the power receiving element 422 may extend along a length L (FIG. 4) of the band 404. The power receiving element 422 may be shaped to form or otherwise define a pattern on the band 404 along its length L. The pattern of the power receiving element 422 may span or traverse a width W of the band along its length L. For example, the power receiving element 422 shown in FIG. 4, has a serpentine shape to it that traverses back and forth across the width W of band 404. In some embodiments, the power receiving element 422 may have a shape that is symmetric about a longitudinal axis 412 of the band 404.

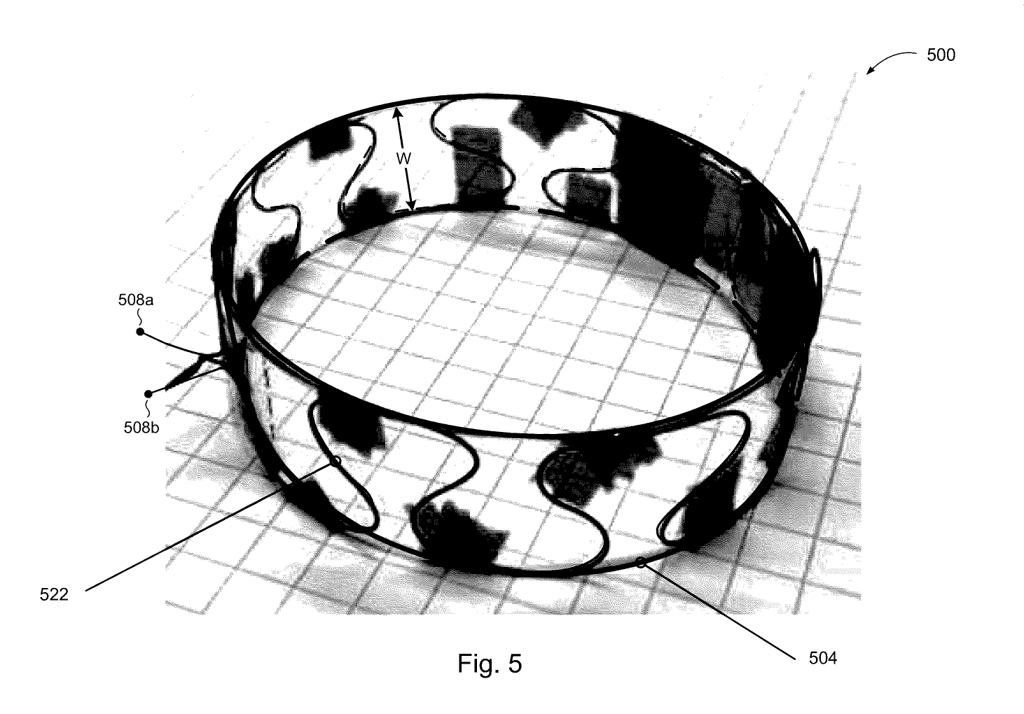

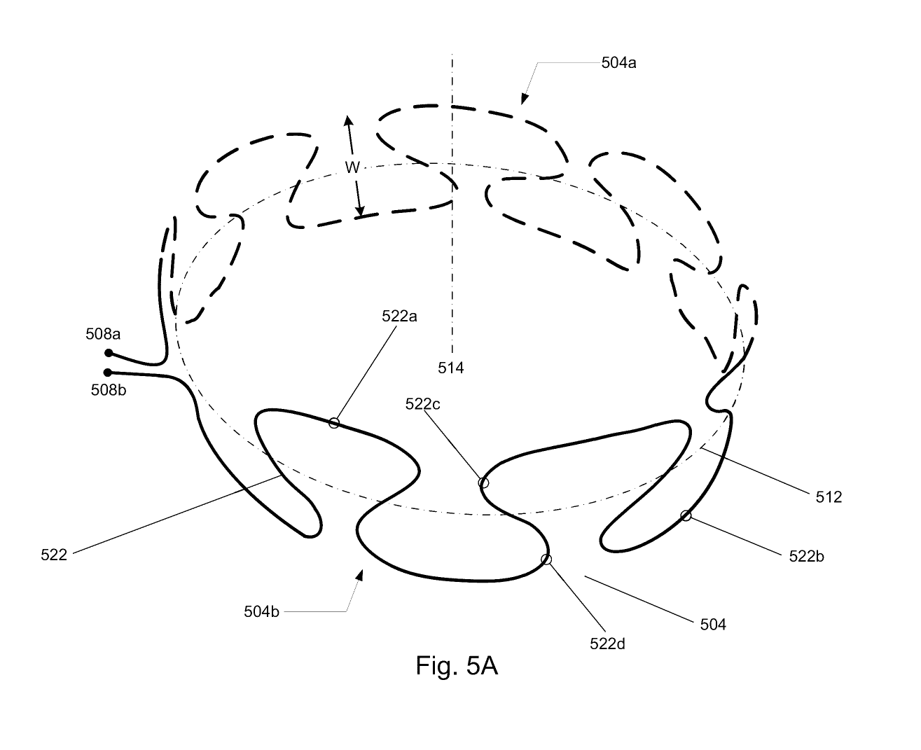

FIG. 5 shows a wire-frame model 500 of a band 504 and power receiving element 522 constructed in accordance with the present disclosure, highlighting the shape of the power receiving element 522. The band 504 was formed from a plastic substrate and is shown in the CLOSED configuration. The power receiving element 522 is formed across the width W of band 504 and encircles the CLOSED band. Terminals 508a, 508b of the power receiving element 522 may connect to suitable electronics, which are not included in the model 500.

FIG. 5A is a schematic illustration of the photograph shown in FIG. 5. In embodiments according to the present disclosure, the power receiving element 522 may wind around the band 504 in a pattern that zigzags across or otherwise repeatedly crosses the longitudinal axis 512 of the band 504. The power receiving element 522 may have portions 522a, 522b that run substantially parallel to the longitudinal axis 512. In some embodiments, the parallel portions 522a, 522b may run near the top edge 504a and the bottom edge 504b, respectively, of the band 504. In some embodiments, the power receiving element 522 may have portions 522c, 522d that overlap in a direction along a radial axis 514 of the band 504.

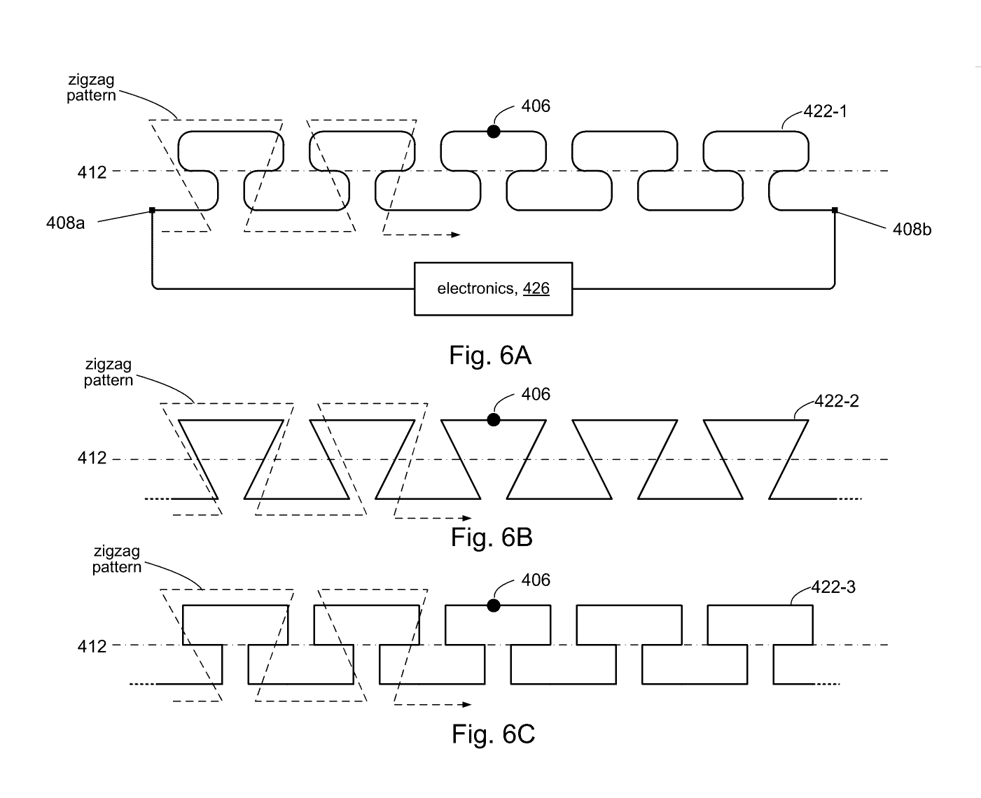

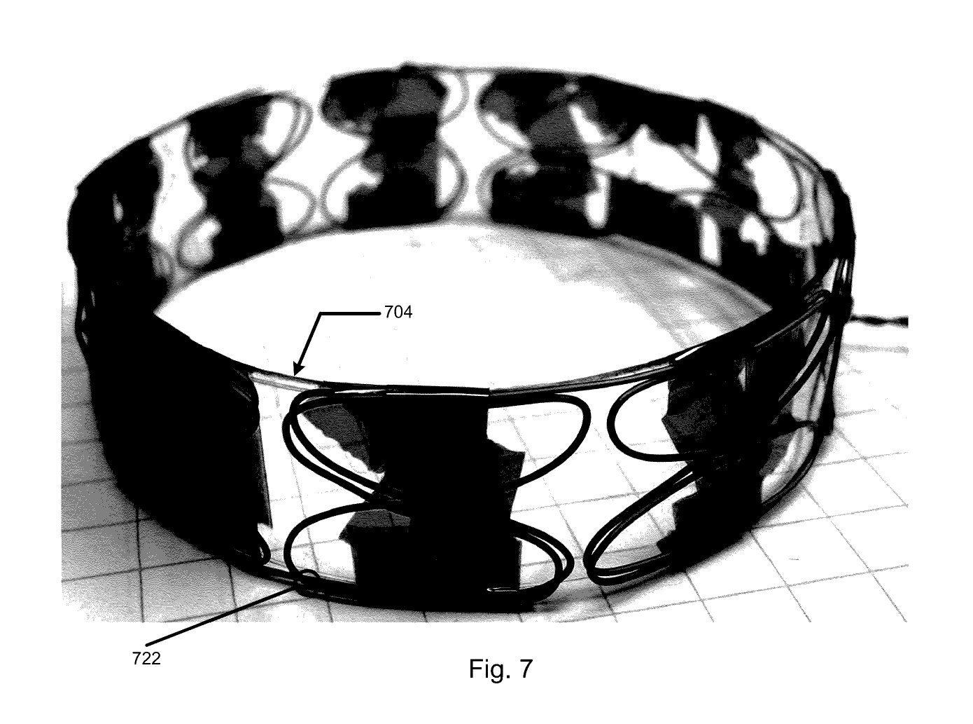

FIGS. 6A, 6B, 6C illustrate examples of various patterns that the power receiving element 422 may be formed or otherwise shaped into. FIG. 6A illustrates a serpentine shaped power receiving element 422-1. FIG. 6B shows a triangular shaped power receiving element 422-2. FIG. 6C shows a rectangular shaped power receiving element 422-3. It will be appreciated that other geometric shapes are possible; for example, hexagonal, octagonal, and so on. As can be seen in the figures, in some embodiments, the pattern of the power receiving element (e.g., 422-1) may be a repeating pattern. In addition, power receiving elements (e.g., 422-1), in accordance with the present disclosure, may have a pattern (may be referred to as a zigzag pattern) that traverses back and forth along the direction of the longitudinal axis 412, as shown in FIGS. 6A-6C. This aspect of the present disclosure will be discussed further.

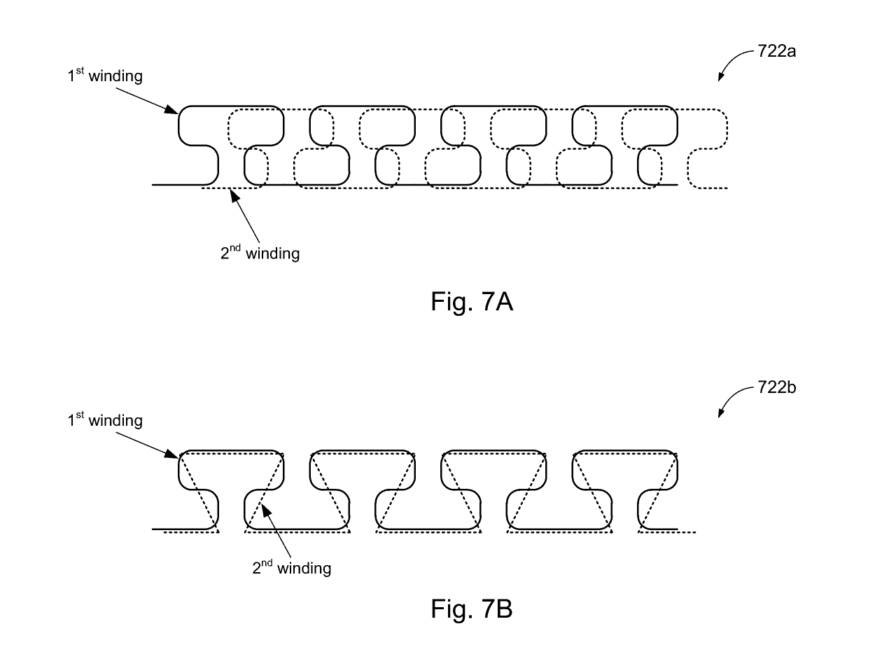

The power receiving element 422 shown in FIG. 4B illustrates an example of a single turn wound around the circumference of the band 404 in the CLOSED configuration. See also FIG. 5. In other embodiments, the power receiving element 422 may have one or more additional turns. Referring to FIG. 7, for example, a power receiving element 722 may be wound about the circumference of band 704 two or more times.

The embodiment in FIG. 7 shows that, in some embodiments, the pattern in the first winding is substantially aligned with the pattern in the second winding. In other embodiments, the patterns in a subsequent winding may not align with the pattern in a previous winding. FIG. 7A, for example, illustrates a portion of a power receiving element 722a that comprises two windings. The figure shows that the pattern in the 2^{nd} winding does not line up (not aligned) with the pattern in the 1^{st} winding.

The embodiment in FIG. 7 shows that, in some embodiments, the same pattern is used with each winding of the power receiving element 722. In other embodiments, the pattern in one winding may be different from the pattern in a subsequent winding. FIG. 7B, for example, illustrates a portion of a power receiving element 722b having two windings. The figure shows that the pattern in the 1^{st} winding has a curved, serpentine shape, while the pattern in the 2^{nd} winding is triangular in shape. The power receiving element 722b shows the respective patterns of the 1^{st} and 2^{nd} windings to be aligned. It will be appreciated that in some embodiments, the patterns between the 1^{st} and 2^{nd} windings in power receiving element 722b may be out of alignment, in addition to being different patterns.

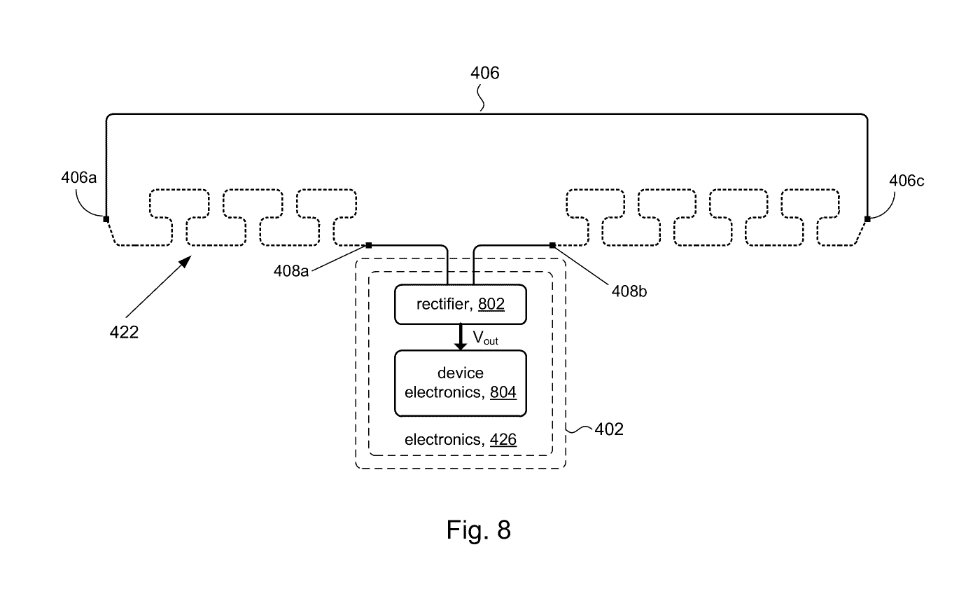

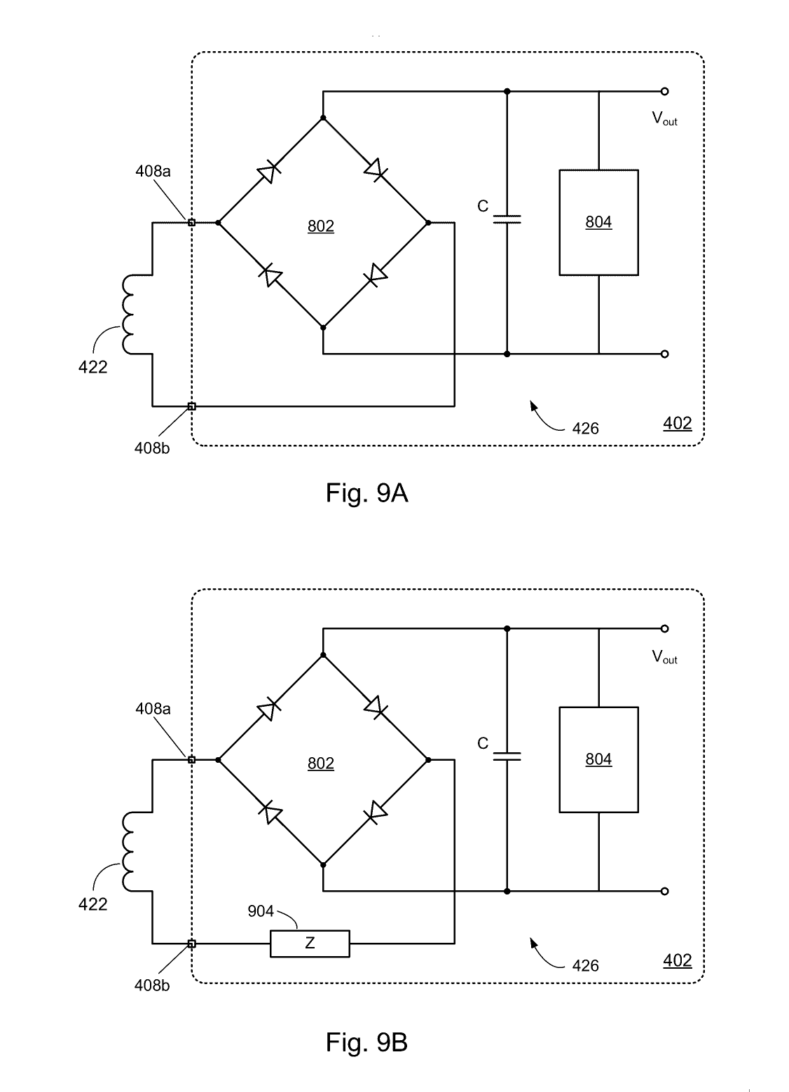

FIG. 8 shows an example of the electronics 426 (FIG. 4) that may be included in the body 402 of a wearable device 400 in accordance with the present disclosure. The electronics 426 may include means for generating wirelessly received power for the electronic device 400 from power induced in the power receiving element 422. In some embodiments, for example, the electronics 426 may include a rectifier circuit 802 and device electronics 804 of the wearable device 40. The power receiving element 422 may connect to the rectifier circuit 802, for example, via terminals 408a, 408b. The rectifier circuit 802 may produce a DC voltage Vₒᵤₜ that can be provided to power the device electronics 804. FIG. 9A, for example, illustrates that in some embodiments, the rectifier circuit 802 may be a full wave rectifier. It will be appreciated, however, that rectifier 802 may comprise any suitable means for rectifying power induced in the power receiving element 422. FIG. 9B shows that in some embodiments, the electronics 426 may include a tuning circuit 904. The tuning circuit 904 may be configured as a means for tuning or otherwise setting a resonant frequency of the power receiving element 422 to the frequency of an externally generated AC magnetic field (e.g., charging field from a power transmitting unit of a wireless charging system).

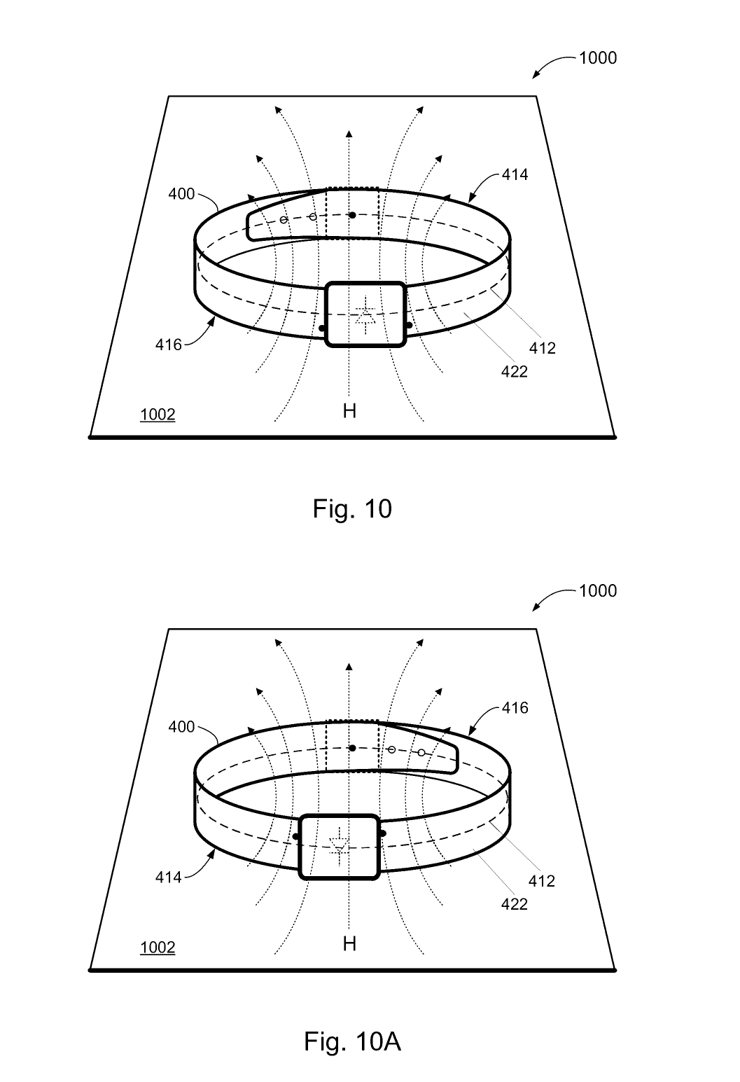

FIG. 10 shows electronic device 400 (FIG. 4) placed on the charging surface 1002 of a wireless power transmitting unit 1000. In operation, an external AC magnetic field H (charging field) generated by the wireless power transmitting unit 1000 may magnetically couple to the power receiving element 422. The resulting AC current induced in the power receiving element 422 may be rectified (e.g., using rectifier 802, FIG. 9A) to produce a DC voltage (e.g., Vₒᵤₜ).

As mentioned above, the power receiving element 422 in accordance with the present disclosure may be symmetric about the longitudinal axis 412 of the band 404 of the electronic device 400. As a result of its symmetric shape, the power receiving element 422 can couple to the externally generated magnetic field H with substantially equal strength irrespective of which side 414, 416 the electronic device 400 is placed on at a given location of the charging surface 1002.

FIG. 10, for example, shows the electronic device 400 lying on its side 416 on the charging surface 1002. For the position shown in FIG. 10, suppose M_{side1} represents the mutual coupling between the externally generated magnetic field H and the power receiving element 422. FIG. 10A shows the electronic device 400 lying on its side 414 in the same location on the charging surface 1002. Suppose, for FIG. 10A, that M_{side2} represents the mutual coupling between the externally generated magnetic field H and the power receiving element 422. Since the power receiving element 422 may have a symmetrical pattern (e.g., FIGS. 4 and 6A-6C) that is symmetric about the longitudinal axis 412, M_{side1} may be equal to M_{side2}.

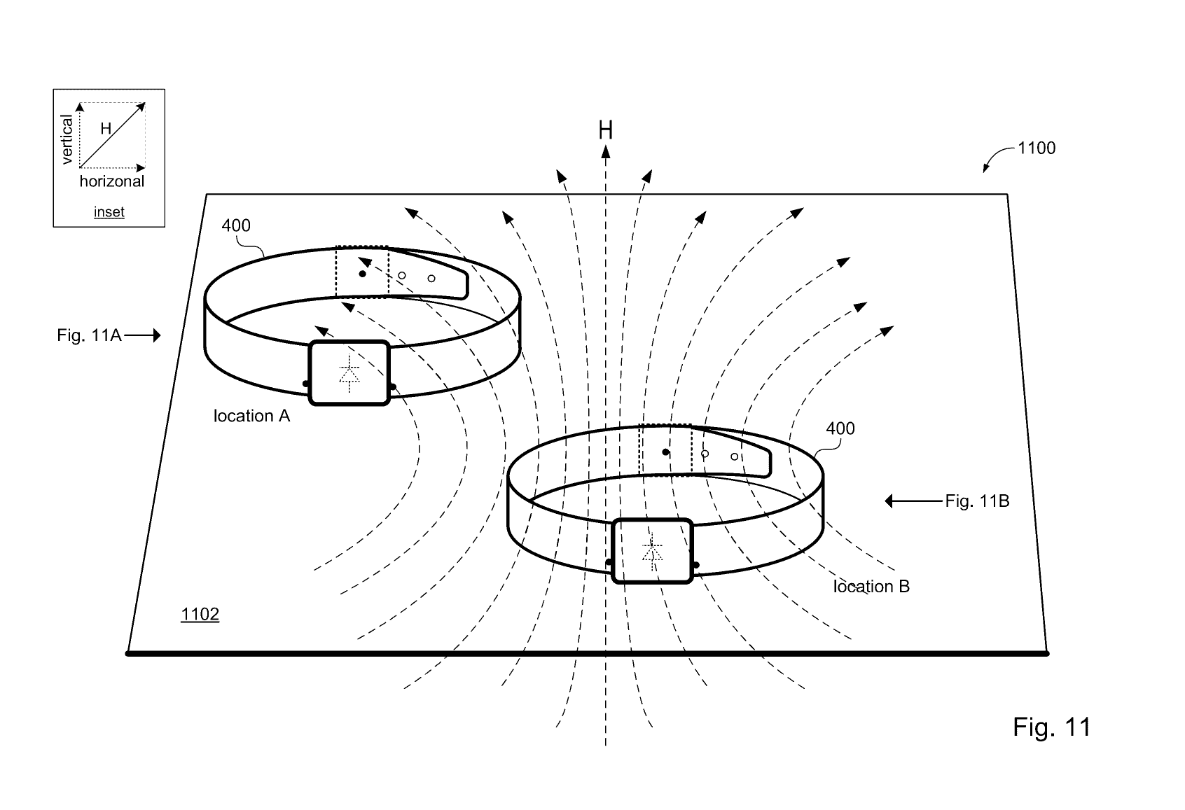

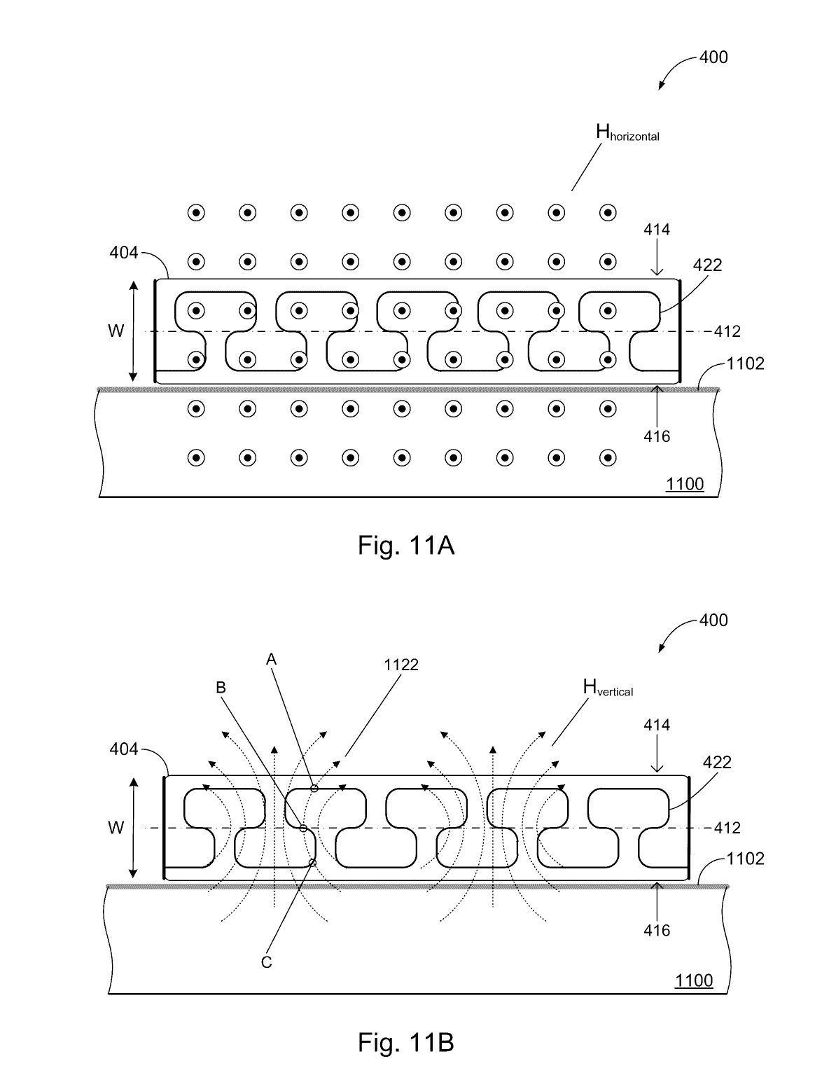

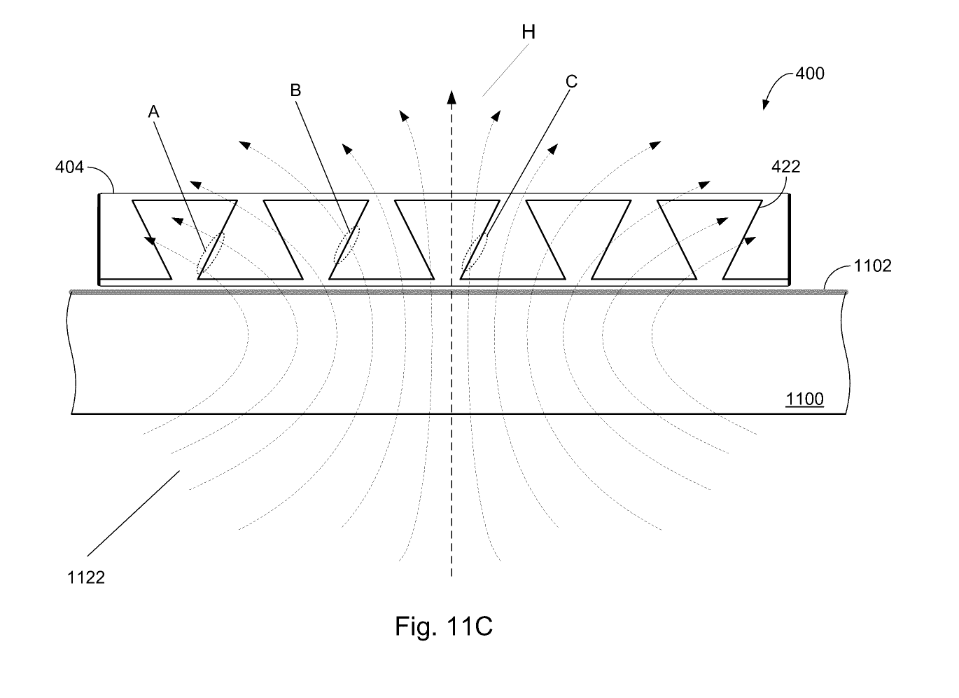

FIG. 11 shows electronic device 400 in alternative locations A and B on the charging surface 1102 of a wireless power transmitting unit 1100. FIG. 11 illustrates that different locations on the charging surface 1102 may expose the electronic device 400 to components (see inset) of the externally generated magnetic field H with different strengths. At location A on the charging surface 1102, for example, the horizontal components of the magnetic field H may be stronger than the vertical components. At location B on the charging surface 1102, the vertical components of the magnetic field H may be stronger than the horizontal components.

Recall from FIGS. 6A-6C that a power receiving element (e.g., 422a) in accordance with the present disclosure, may have a pattern that traverses back and forth along the direction of the longitudinal axis 412. This zigzag pattern in the power receiving element 422 can increase the effective area for coupling with the magnetic field H, and hence increase the induced voltage in the power receiving element 422. The side view of shown in FIG. 11A emphasizes, for explanatory purposes, the predominantly horizontal components of magnetic field H at location A on the charging surface 1102. The side view of shown in FIG. 11B likewise emphasizes, for explanatory purposes, the predominantly vertical components of magnetic field H at location B on the charging surface 1102.

As can be observed in FIG. 11A, the pattern made in power receiving element 422 results in the power receiving element 422 intersecting more of the horizontal components of magnetic field H (and hence increases coupling) than if the power receiving element 422 was a linear element. As can be seen in FIG. 11A, a pattern that spans the width W of the band 404 along the band's length (or circumference) may be effective in terms of increasing the effective coupling area. Moreover, in accordance with embodiments of the present disclosure, the pattern, in addition to spanning the width W, may be symmetrical about the longitudinal axis 412 so that the mutual coupling can be substantially the same whether the electronic device 400 is placed on one side 414 or the other 416 on the charging surface 1102. This can be beneficial to the user, since the user can place the electronic device 400 on either side 414 or 416 without having to be conscious of which side is more effective for wireless power transfer to the electronic device 400.

A similar observation can be made in FIG. 11B with regard to vertical magnetic field components. The pattern made in power receiving element 422 results in the vertical components of magnetic field H intersecting more of the power receiving element 422 (and hence increases coupling) than if the power receiving element 422 was a linear element. As can be seen in FIG. 11B, a pattern that spans the width W of the band 404 along the band's length (or circumference) may be effective in terms of increasing the effective coupling area. More particularly, for example, given flux lines 1122 of the magnetic field H may intersect the power receiving element 422 at several locations A, B, C. Moreover, in accordance with embodiments of the present disclosure, the pattern may also be symmetrical about the longitudinal axis 412 so that the mutual coupling can be substantially the same whether the electronic device 400 is placed on one side 414 or the other 416 on the charging surface 1102.

FIG. 11C shows that the flux lines 1122 of the magnetic field H may intersect different portions of a power receiving element 422 at different angles. For example, at location A on the power receiving element 422, the flux lines 1122 intersect at about a 90°, while at locations B and C on the power receiving element 422, the flux lines 1122 intersect at shallower angles. The different angles of intersection between the power receiving element 422 and the flux lines 1122 can contribute differently to the overall coupling. Accordingly, at least one or more portions or locations (e.g. location A) on the power receiving element 422 may be at an angle to allow sufficient coupling to the magnetic field H regardless of the placement location of the electronic device 400 on the charging surface 1102.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A wearable electronic device comprising:
a band configured to secure the wearable electronic device to a user; and
a power receiving element arranged along a length of the band and shaped to form a pattern that spans a width of the band,
the power receiving element configured to couple to an externally generated magnetic field to wirelessly receive power from a source of the externally generated magnetic field.

2. The device of claim 1, wherein first flux lines of the externally generated magnetic field intersect the power receiving element at a plurality of locations on the width of the power receiving element.

3. The device of claim 1, wherein the pattern is symmetric about a longitudinal axis of the band.

4. The device of claim 1, wherein the power receiving element couples equally in strength to the externally generated magnetic field when a first side of the electronic device lies on a charging device that produces the externally generated magnetic field as it does when the electronic device lies on the charging device on a second side of the electronic device.

5. The device of claim 1, wherein the pattern is a repeating pattern.

6. The device of claim 1, wherein the pattern traverses back and forth across the width of the band.

7. The device of claim 1, wherein:
the power receiving element comprises a first segment and a second segment; and
the band comprises a first band segment having arranged therewith the first segment of the power receiving element, a second band segment having arranged therewith the second segment of the power receiving element, and an engagement mechanism configured to mechanically engage and disengage the first and second band segments.

8. The device of claim 1, wherein the power receiving element defines a single turn around a circumference of the band when the band is in a CLOSED configuration.

9. The device of claim 1, wherein the power receiving element defines at least two turns around a circumference of the band when the band is in a CLOSED configuration.

10. A method of wireless power transfer comprising:
magnetically coupling to an externally generated magnetic field via a power receiving element incorporated with a band that is configured to secure a wearable electronic device to a user, the power receiving element extending a length of the band and traversing back and forth across a width of the band; and
generating wirelessly received power for the wearable electronic device from power induced in the power receiving element from the externally generated magnetic field.

11. The method of claim 10, further comprising intersecting first flux lines of the externally generated magnetic field at a plurality of locations on the power receiving element.

12. The method of claim 10, further comprising coupling the externally generated magnetic field to the power receiving element equally strongly irrespective of whether a first side of the band or a second side of the band is closer to a charging surface from which the externally generated magnetic field emanates.

13. The method of claim 10, wherein the power receiving element has a pattern that is symmetric about a longitudinal axis along the length of the band.

14. The method of claim 10, wherein the power receiving element traverses back and forth across the width of the band with a repeating pattern.

15. The method of claim 10, wherein the power receiving element extends around a circumference of the band one or more times.

16. The method of claim 10, further comprising connecting together a first segment of the power receiving element and a second segment of the power receiving element.

17. The method of claim 16, further comprising configuring the band to a CLOSED position to connect together a first segment of the power receiving element and a second segment of the power receiving element.

18. The method of claim 10, further comprising setting a resonant frequency of the power receiving element substantially equal to a frequency of the externally generated magnetic field.

19. The method of claim 10, further comprising rectifying the power induced in the power receiving element to produce the wirelessly received power.

20. An electronic device comprising:
means for magnetically coupling to an externally generated magnetic field, the means for magnetically coupling arranged with a band that is configured to secure a wearable electronic device to a user, the means for magnetically coupling extending a length of the band and traversing back and forth across a width of the band; and
means for generating wirelessly received power for the wearable electronic device from power induced in the means for magnetically coupling.

21. The device of claim 20, wherein the means for magnetically coupling couples equally strongly to the externally generated magnetic field irrespective of whether a first side of the band or a second side of the band is closer to a charging surface from which the externally generated magnetic field emanates.

22. The device of claim 20, wherein the means for magnetically coupling has a pattern that is symmetric about a longitudinal axis along the length of the band.

23. The device of claim 20, wherein the means for magnetically coupling traverses back and forth across the width of the band with a repeating pattern.

24. The device of claim 20, wherein the means for magnetically coupling extends around a circumference of the band one or more times.

25. The device of claim 20, further comprising means for connecting together first and second segments that comprise the means for magnetically coupling.

26. The method of claim 20, further comprising means for configuring the band to a CLOSED position to connect together first and second segments that comprise the means for magnetically coupling.

27. The device of claim 20, further comprising means for setting a resonant frequency of the means for magnetically coupling substantially equal to a frequency of the externally generated magnetic field.

28. The device of claim 20, further comprising means for rectifying the power induced in the means for magnetically coupling to generate the wirelessly received power.

29. An apparatus for wireless power transfer, comprising:
a band configured to secure an electronic device to a user; and
a power receiving element comprising a winding of conductive material arranged to repeatedly cross a longitudinal axis running along a length of the band and that forms a pattern along a width of the band,
the power receiving element configured to inductively couple to an externally generated magnetic field to wirelessly receive power from a source of the externally generated magnetic field.

30. The apparatus of claim 29, wherein a portion of a first segment of the pattern that runs along an upper portion of the band substantially parallel to the longitudinal axis overlaps a portion of a second segment of the pattern that runs along a lower portion of the band substantially parallel to the longitudinal axis.
